(19) United States
(12) Patent Application Publication
(10) Pub. No.: US 2024/0291153 A1
(43) Pub. Date: Aug. 29, 2024

(54) ANTENNA STRUCTURE AND IMAGE DISPLAY DEVICE INCLUDING THE SAME

(71) Applicant: DONGWOO FINE-CHEM CO., LTD., Jeollabuk-do (KR)

(72) Inventors: KI HUN SUNG, Jeollabuk-do (KR); SUNG JOON HONG, Jeollabuk-do (KR); DAE KYU KIM, Jeollabuk-do (KR); HEE JUN PARK, Jeollabuk-do (KR); MEE AE HUR, Jeollabuk-do (KR)

(21) Appl. No.: 18/582,827

(22) Filed: Feb. 21, 2024

(30) Foreign Application Priority Data
Feb. 24, 2023 (KR) 10-2023-0024910

(51) Int. Cl. H01Q 9/04; G01S 13/62; H01Q 1/22; H01Q 21/08

(52) U.S. Cl. CPC H01Q 9/0407; G01S 13/62; H01Q 1/22; H01Q 21/08

(57) ABSTRACT

An antenna structure may include a transmission antenna unit group, and a reception antenna unit group spaced apart from the transmission antenna unit group in a first direction. The transmission antenna unit group includes a first transmission antenna unit and a second transmission antenna unit having a length in a second direction greater than a length of the first transmission antenna unit in the second direction, the second direction being perpendicular to the first direction. The reception antenna unit group includes a plurality of reception antenna units spaced apart from the first transmission antenna unit in the first direction and being arranged in a single row.

### CROSS-REFERENCE TO RELATED APPLICATION AND CLAIM OF PRIORITY

This application claims the benefit under 35 USC § 119 of Korean Patent Application No. 10-2023-0024910 filed on Feb. 24, 2023 in the Korean Intellectual Property Office (KIPO), the entire disclosure of which is incorporated herein by reference for all purposes.

### BACKGROUND

### 1. Field

The present invention relates to an antenna structure and an image display device including the same.

### 2. Description of the Related Art

As information technologies have been developed, a wireless communication technology such as Wi-Fi, Bluetooth, etc., or a non-contact sensing such as a gesture detection and a motion recognition is being applied to or embedded in image display devices, electronic devices and architecture.

Additionally, with the development of mobile communication technologies, an antenna for performing a communication in high-frequency or ultra-high frequency bands is being applied or embedded into various mobile devices, the Internet of Things (IoT), autonomous vehicles, etc.

For example, the wireless communication technology is being implemented and combined with an image display device in the form of a smartphone. Accordingly, the antenna may be coupled to the image display device to perform a communication function, an information transmission function, etc.

As the image display device on which the antenna is employed becomes thinner and lighter, a space occupied by the antenna may also decrease. Accordingly, the antenna may be included in the form of a film or patch on a display panel so as to insert the antenna in a limited space.

However, the antenna capable of implementing high-precision sensing performance such as motion recognition, distance measurement, position detection, etc., may not be implemented in the limited space.

### SUMMARY

According to an aspect of the present invention, there is provided an antenna structure having improved sensitivity.

According to an aspect of the present invention, there is provided a motion sensor including the antenna structure.

According to an aspect of the present invention, there is provided a radar sensor including the antenna structure.

According to an aspect of the present invention, there is provided an image display device including an antenna structure having improved sensitivity.

(1) An antenna structure, including: a transmission antenna unit group; and a reception antenna unit group spaced apart from the transmission antenna unit group in a first direction, wherein the transmission antenna unit group includes: a first transmission antenna unit; and a second transmission antenna unit having a length in a second direction greater than a length of the first transmission antenna unit in the second direction, the second direction being perpendicular to the first direction, wherein the reception antenna unit group includes a plurality of reception antenna units spaced apart from the first transmission antenna unit in the first direction and being arranged in a single row along the first direction.

(2) The antenna structure according to the above (1), wherein the second transmission antenna unit is spaced apart from the reception antenna unit group in the first direction with the first transmission antenna unit interposed therebetween.

(3) The antenna structure according to the above (1), wherein the first transmission antenna unit includes a first transmission radiator, a first transmission transmitting line connected to the first transmission radiator, and a first transmission sub-ground disposed around the first transmission transmitting line, and the second transmission antenna unit includes a second transmission radiator, a second transmission transmitting line connected to the second transmission radiator, and a second transmission sub-ground disposed around the second transmission transmitting line.

(4) The antenna structure according to the above (3), wherein a spacing distance between the first transmission radiator and the second transmission radiator in the first direction is in a range from 80% to 150% of a half-wavelength (λ/2) of a maximum resonance frequency, and a spacing distance between the first transmission radiator and the second transmission radiator in the second direction is in a range from 80% to 150% of the half-wavelength (λ/2) of the maximum resonance frequency.

(5) The antenna structure according to the above (3), wherein a length of the second transmission transmitting line in the second direction is greater than a length of the first transmission transmitting line in the second direction.

(6) The antenna structure according to the above (3), wherein a length of the second transmission sub-ground in the second direction is greater than a length of the first transmission sub-ground in the second direction.

(7) The antenna structure according to the above (3), wherein the first transmission antenna unit further includes a first transmission signal pad connected to one end portion of the first transmission transmitting line, and a first transmission ground pad disposed around the first transmission signal pad, and the second transmission antenna unit further includes a second transmission signal pad connected to one end portion of the second transmission transmitting line, and a second transmission ground pad disposed around the second transmission signal pad.

(8) The antenna structure according to the above (7), wherein a length of the first transmission sub-ground in the first direction is smaller than a length of the first transmission ground pad in the first direction.

(9) The antenna structure according to the above (1), wherein each of the plurality of reception antenna units includes a reception radiator, and a plurality of the reception radiators are ranged in a single row along the first direction.

(10) The antenna structure according to the above (9), wherein a spacing distance between neighboring reception radiators among the reception radiators included in the plurality of reception antenna units is in a range from 80% to 150% of a half-wavelength (λ/2) of a maximum resonance frequency.

(11) The antenna structure according to the above (9), wherein each of the plurality of reception antenna units includes a reception transmitting line connected to the reception radiator and a reception sub-ground disposed around the reception transmitting line.

(12) The antenna structure according to the above (11), wherein the reception antenna unit further includes a reception signal pad connected to one end portion of the reception transmitting line, and a reception ground pad disposed around the reception signal pad.

(13) The antenna structure according to the above (1), further including a dielectric layer on which the transmission antenna unit group and the reception antenna unit group are disposed, wherein the transmission antenna unit group and the reception antenna unit group are disposed at the same level on the dielectric layer.

(14) A motion recognition sensor including the antenna structure according to the above-described embodiments.

(15) A radar sensor comprising the antenna structure according to the above-described embodiments.

(16) An image display device, including: a display panel; and the antenna structure according to the above-described embodiments disposed on the display panel.

In example embodiments, the antenna structure may include a transmission antenna unit group and a reception antenna unit group. The transmission antenna unit group may include a first transmission antenna unit and a second transmission antenna unit having a length larger than that of the first transmission antenna unit. A virtual radiator may be formed in the reception antenna unit group by the second transmission antenna unit. Accordingly, an angular resolution of a motion recognition from the antenna structure may be improved, and precision of motion tracking in azimuth and elevation angle directions may be enhanced.

In some embodiments, the virtual radiators spaced apart in a direction perpendicular to an arrangement direction of reception radiators may be formed by the second transmission antenna unit. Accordingly, a change of signal intensities at two orthogonal axes may be measured even without using a reception transmitting line including a bent portion so that a positional change of a sensing object may be detected.

For example, each of the antenna units may include a radiator, a transmitting line connected to the radiator, and a sub ground disposed around the transmitting line. Accordingly, driving properties of the antenna unit may be improved, and radiation directivity and gain may be enhanced to improve signal sensitivity.

In some embodiments, the antenna structure may be electrically coupled to a motion sensor driving circuit or a radar processor through a circuit board. Accordingly, a signal change by the sensing object may be transmitted to the motion sensor driving circuit or the radar processor, and positions and distances in all directions may be measured based on the collected signal information.

### BRIEF DESCRIPTION OF THE DRAWINGS

FIG. 1 is a schematic plan view illustrating an antenna structure in accordance with exemplary embodiments.

FIG. 2 is a schematic plan view describing a formation of a virtual radiator.

FIG. 3 is a graph showing antenna gains according to frequencies in Example and Comparative Example.

FIGS. 4 and 5 are schematic plan views illustrating antenna structures in accordance with exemplary embodiments.

FIG. 6 is a schematic plan view illustrating an antenna unit in accordance with exemplary embodiments.

FIG. 7 is a schematic plan view illustrating an antenna structure in accordance with exemplary embodiments.

FIGS. 8 and 9 are a schematic plan view and a cross-sectional view illustrating an image display device in accordance with exemplary embodiments.

### DETAILED DESCRIPTION OF THE EMBODIMENTS

According to exemplary embodiments of the present invention, an antenna structure includes a plurality of antenna unit groups.

A motion recognition sensor, a radar and an image display device according to embodiments of the present invention may include the antenna structure. The antenna structure may be applied to various objects or structures such as a vehicle, a home electronic appliance, an architecture, etc.

Hereinafter, the present invention will be described in detail with reference to the accompanying drawings. However, those skilled in the art will appreciate that such embodiments described with reference to the accompanying drawings are provided to further understand the spirit of the present invention and do not limit subject matters to be protected as disclosed in the detailed description and appended claims.

The terms “first”, “second”, “third”, “fourth”, “one end”, “other end”, “upper side”, “lower side”, “upper side”, “lower side”, etc., as used herein are not intended to limit an absolute position or order, but is used in a relative sense to distinguish different components or elements.

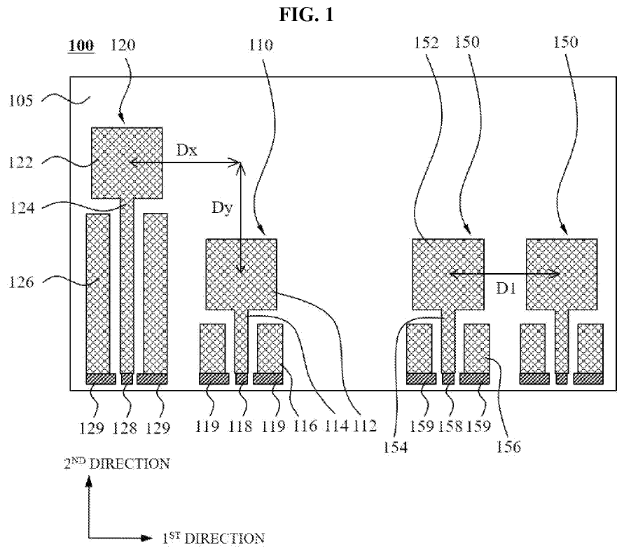

FIG. 1 is a schematic plan view illustrating an antenna structure in accordance with exemplary embodiments.

Referring to FIG. 1, the antenna structure 100 includes a transmission antenna unit group and a reception antenna unit group spaced apart from each other in a first direction.

For example, the antenna structure 100 may further include a dielectric layer 105 on which the transmission antenna unit group and the reception antenna unit group are arranged.

The first direction may be, e.g., a width direction of the dielectric layer 105 and/or the antenna structure 100.

The dielectric layer 105 may include, e.g., a transparent resin film. For example, the dielectric layer 105 may include a polyester-based resin such as polyethylene terephthalate, polyethylene isophthalate, polyethylene naphthalate and polybutylene terephthalate; a cellulose-based resin such as diacetyl cellulose and triacetyl cellulose; a polycarbonate-based resin; an acrylic resin such as polymethyl (meth)acrylate and polyethyl (meth)acrylate; a styrene-based resin such as polystyrene and an acrylonitrile-styrene copolymer; a polyolefin-based resin such as polyethylene, polypropylene, a cycloolefin or polyolefin having a norbornene structure and an ethylene-propylene copolymer; a vinyl chloride-based resin; an amide-based resin such as nylon and an aromatic polyamide; an imide-based resin; a polyethersulfone-based resin; a sulfone-based resin; a polyether ether ketone-based resin; a polyphenylene sulfide resin; a vinyl alcohol-based resin; a vinylidene chloride-based resin; a vinyl butyral-based resin; an allylate-based resin; a polyoxymethylene-based resin; an epoxy-based resin; a urethane or acrylic urethane-based resin; a silicone-based resin, etc. These may be used alone or in a combination of two or more thereof.

The dielectric layer 105 may include an adhesive material such as an optically clear adhesive (OCA), an optically clear resin (OCR), etc.

In some embodiments, the dielectric layer 105 may include an inorganic insulating material such as glass, silicon oxide, silicon nitride, silicon oxynitride, etc.

In an embodiment, the dielectric layer 105 may be provided as a substantially single layer.

In an embodiment, the dielectric layer 105 may include a multi-layered structure of at least two layers. For example, the dielectric layer 105 may include a substrate layer and an antenna dielectric layer, and may include an adhesive layer between the substrate layer and the antenna dielectric layer.

Capacitance or inductance for the antenna structure 100 may be formed by the dielectric layer 105, so that a frequency band at which the antenna structure may be driven or operated may be adjusted. In some embodiments, a dielectric constant of the dielectric layer 105 may be adjusted in a range from about 1.5 to about 12. If the dielectric constant exceeds about 12, a driving frequency may be excessively decreased, and driving in a desired high frequency or ultrahigh frequency band may not be implemented.

In some embodiments, a ground layer (not illustrated) may be disposed on a bottom surface of the dielectric layer 105. Generation of an electric field in a transmitting line may be more promoted by the ground layer, and an electrical noise around a feeding line may be absorbed or shielded.

In some embodiments, the ground layer may be included an individual member of the antenna structure 100. In some embodiments, a conductive member of an image display device to which the antenna structure 100 is applied may serve as the ground layer 90.

For example, the conductive member may include various electrodes or wirings such as, e.g., a gate electrode, a source/drain electrode, a pixel electrode, a common electrode, a scan line, a data line, etc., included in a thin film transistor (TFT) array of a display panel.

In an embodiment, a metallic member disposed at a rear portion of the image display device such as a SUS plate, a sensor member such as a digitizer, a heat dissipation sheet, etc., may serve as the ground layer.

In example embodiments, the transmission antenna unit group includes a first transmission antenna unit 110 and a second transmission antenna unit 120.

For example, a length of the second transmission antenna unit 120 in a second direction perpendicular to the first direction may be greater than a length of the first transmission antenna unit 110 in the second direction. Accordingly, a virtual radiator of the reception antenna unit group may be formed.

The second direction may be, e.g., a length direction of the dielectric layer 105 and/or the antenna structure 100.

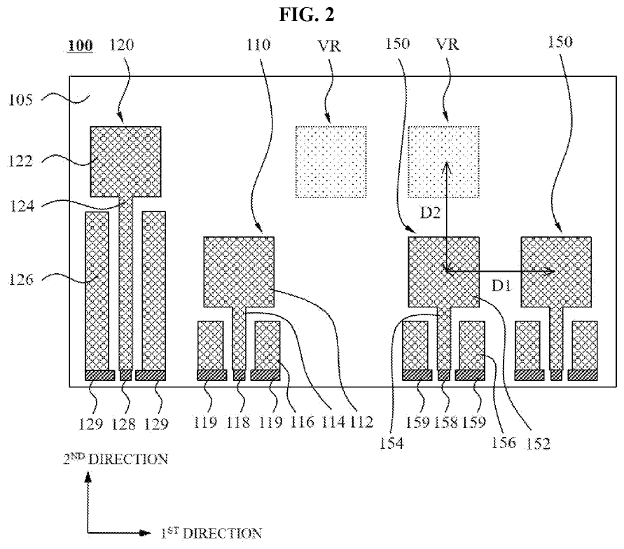

FIG. 2 is a schematic plan view describing a formation of a virtual radiator.

Referring to FIG. 2, a virtual radiator VR may be formed in the reception antenna unit group by the second transmission antenna unit 120. For example, the virtual radiator VR may indicate a virtual region which does not physically exist but may serve as a reception radiator.

For example, the virtual radiator VR may have the same shape, size, spacing distance between the radiators and arrangement as those of reception radiator 152 included in the reception antenna unit group.

For example, a spacing distance in the first direction between the adjacent virtual radiator VR and the reception radiator 152 may be substantially the same as a spacing distance in the first direction between transmission radiators 112 and 122. For example, a spacing distance in the second direction between the adjacent virtual radiator VR and the reception radiator 152 may be substantially the same as a spacing distance in the second direction between transmission radiators 112 and 122.

For example, the formation position of the virtual radiator VR may be adjusted according to the spacing distance between the transmission radiators 112 and 122.

From the formation of the virtual radiator VR, substantially the same effect as that of disposing an additional reception radiator in the reception antenna unit group may be obtained. Accordingly, an angular resolution of motion recognition of the antenna structure 100 may be improved, and precision of a motion tracking in azimuth and elevation angle directions may be improved.

Referring again to FIG. 1, the first transmission antenna unit 110 may include the first transmission radiator 112, a first transmission transmitting line 114 connected to the first transmission radiator 112, and a first transmission sub-ground 116 disposed around the first transmission transmitting line 114. The second transmission antenna unit 120 may include a second transmission radiator 122, a second transmission transmitting line 124 connected to the second transmission radiator 122, and a second transmission sub-ground 126 disposed around the second transmission transmitting line 124.

For example, the first transmission sub-ground 116 and the second transmission sub-ground 126 may be physically spaced apart from the first transmission transmitting line 114 and the second transmission transmitting line 124, respectively. In an embodiment, the first transmission sub-ground 116 and the second transmission sub-ground 126 may extend in parallel to an extension direction of the first transmission transmitting line 114 and the second transmission transmitting line 124, respectively.

In an embodiment, a pair of the first transmission sub-grounds 116 may be disposed to be spaced apart from each other with the first transmission transmitting line 114 interposed therebetween. In an embodiment, a pair of the second transmission sub-grounds 126 may be disposed to be spaced apart from each other with the second transmission transmitting line 124 interposed therebetween. The transmission sub-grounds 116 and 126 may be disposed around the transmission transmitting lines 114 and 124, so that a gain and a beam width of the antenna structure 100 may be enhanced.

In example embodiments, signal interference and disturbance between a plurality of transmission antenna units 110 and 120 may be suppressed by the transmission sub-grounds 116 and 126. Thus, the gain of the antenna structure 100 may be improved, and noise generation may be suppressed.

In example embodiments, a strong electromagnetic field may be generated in a region between end portions of the transmission transmitting lines 114 and 124 (e.g., a bonding portion with a circuit board) and the transmission radiators 112 and 122, by the transmission sub-grounds 116 and 126. Thus, an electromagnetic field intensity in a direction toward the circuit board may be increased, so that a radiation directivity of the transmission antenna units 110 and 120 may be improved and the beam width may be expanded.

Further, an additional radiation or an auxiliary radiation may be provided by the transmission sub-grounds 116 and 126, and the antenna gain and radiation directivity (e.g., vertical radiation properties) may be improved. Therefore, even in an ultra-high frequency band of 50 GHz or more, the antenna structure 100 may have high signal efficiency and sensitivity, and accuracy of sensing performance may be improved.

In some embodiments, a length of the second transmission transmitting line 124 in the second direction may be greater than a length of the first transmission transmitting line 114 in the second direction. Accordingly, the second transmission radiator 122 and the first transmission radiator 112 may be spaced apart from each other in the second direction. Thus, the virtual radiator VR of the reception antenna unit group may be formed.

In some embodiments, a length of the second transmission sub-ground 126 in the second direction may be greater than a length of the first transmission sub-ground 116 in the second direction. Accordingly, the above-described signal interference of the transmission antenna unit group may be further prevented.

In some embodiments, a spacing distance Dx between the first transmission radiator 112 and the second transmission radiator 122 in the first direction may be greater than or equal to 80% of a half-wavelength (λ/2) of a maximum resonance frequency of the antenna structure 100. A spacing distance Dy between the first transmission radiator 112 and the second transmission radiator 122 in the second direction may be greater than or equal to 80% of the half-wavelength (λ/2) of the maximum resonance frequency.

The term “spacing distance” used herein may refer to the shortest linear distance connecting central points of the radiators in a plan view.

The “spacing distance Dx between the first transmission radiator 112 and the second transmission radiator 122 in the first direction” may be the shortest distance from a point where a virtual line extending in the first direction from a central point of the second transmission radiator 112 meets a virtual line extending in the second direction from a central point of the first transmission radiator 122 to the central point of the second transmission radiator 122.

The “spacing distance (Dy) between the first transmission radiator 112 and the second transmission radiator 122 in the second direction” may be the shortest distance from a point where a virtual line extending from the central point of the second transmission radiator 122 in the first direction meets a virtual line extending in the second direction from the central point of the first transmission radiator 112 to the central point of the first transmission radiator 112.

For example, the spacing distance Dx in the first direction and the spacing distance Dy in the second direction between the first transmission radiator 112 and the second transmission radiator 122 may each be 90% or more, 95% or more, or 100% or more of the half-wavelength (λ/2) of the maximum resonance frequency.

For example, the spacing distance Dx in the first direction and the spacing distance Dy in the second direction between the first transmission radiator 112 and the second transmission radiator 122 may each be 50% or less, 120% or less, or 110% or less of the half-wavelength (λ/2) of the maximum resonance frequency.

For example, the spacing distance Dx in the first direction and the spacing distance Dy in the second direction between the first transmission radiator 112 and the second transmission radiator 122 may each be in a range from 80% to 150% of the half-wavelength (λ/2) of the maximum resonance frequency.

In one embodiment, the spacing distance Dx in the first direction and the spacing distance Dy in the second direction between the first transmission radiator 112 and the second transmission radiator 122 may each be the half-wavelength (λ/2) of the maximum resonance frequency.

Within the range of the spacing distance Dx and Dy, desired radiation properties may be achieved while preventing mutual interference between the first and second transmission antenna units 110 and 120. Thus, signal loss and distortion may be prevented, so that high sensitivity and accuracy may be implemented in, e.g., a motion detection or a distance detection.

For example, the spacing distance Dx in the first direction and the spacing distance Dy in the second direction between the first transmission radiator 112 and the second transmission radiator 122 may be changed, so that the spacing distance between the virtual radiator VR and the reception radiator 152 may be adjusted.

In some embodiments, the first transmission antenna unit 110 may include a first transmission signal pad 118 connected to one end portion of the first transmission transmitting line 114 and a first transmission ground pad 119 disposed around the first transmission signal pad 118. The second transmission antenna unit 120 may include a second transmission signal pad 128 connected to one end portion of the second transmission transmitting line 124 and a second transmission ground pad 129 disposed around the second transmission signal pad 128.

For example, the first transmission ground pad 119 and the second transmission ground pad 129 may be electrically and physically separated from the first transmission signal pad 118 and the second transmission signal pad 128, respectively.

In one embodiment, the first transmission antenna unit 110 may include a pair of the first transmission ground pads 119 spaced apart from each other with the first transmission signal pad 118 interposed therebetween. The second transmission antenna unit 120 may include a pair of the second transmission ground pads 129 spaced apart from each other with the second transmission signal pad 128 interposed therebetween.

For example, the first transmission signal pad 118 and the second transmission signal pad 128 may be provided as substantially integral members with the first transmission transmitting line 114 and the second transmission transmitting line 124, respectively. For example, a terminal end portion of the first transmission transmitting line 114 and a terminal end portion of the second transmission transmitting line 124 may be provided as the first transmission signal pad 118 and the second transmission signal pad 128, respectively.

For example, the first transmission sub-ground 116 and the second transmission sub-ground 126 may extend from the first transmission ground pad 119 and the second transmission ground pad 129, respectively.

In one embodiment, the first transmission sub-ground 116 and the second transmission sub-ground 126 may be formed as a single member integrally connected to the first transmission ground pad 119 and the second transmission ground pad 129, respectively. For example, the first transmission sub-ground 116 may extend from the first transmission ground pad 119 toward the first transmission radiator 112. For example, the second transmission sub-ground 126 may extend from the second transmission ground pad 129 toward the second transmission radiator 122.

In example embodiments, the reception antenna unit group may include a plurality of reception antenna units 150 spaced apart from the first transmission antenna unit 110 in the first direction and arranged in a single row along the first direction.

For example, each of the plurality of the reception antenna units 150 may include a reception 152. The reception radiators 152 may be arranged in a single row along the first direction.

For example, the plurality of the reception antenna units 150 may be arranged along a virtual axis (a first axis) that is parallel to the first direction and commonly passes through central points of the first reception radiators 152.

In an embodiment, the plurality of the reception antenna units 150 may consist of two reception antenna units.

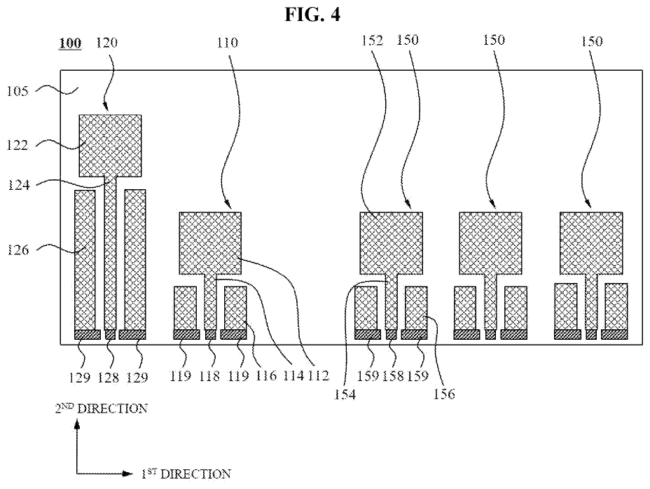

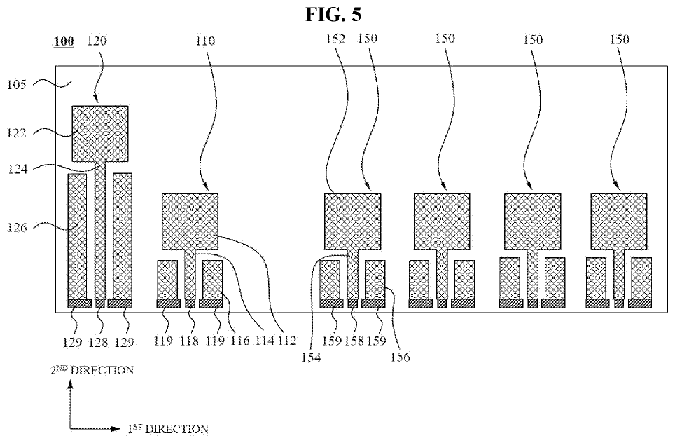

In an embodiment, the plurality of the reception antenna units 150 may consist of three reception antenna units or may include four or more reception antenna units (see FIGS. 4 and 5). Accordingly, angular resolution and detecting precision of the reception antenna unit group may be improved.

As described above, the virtual radiators VR may be formed in the reception antenna unit group by the second transmission antenna unit 120.

For example, the reception radiators 152 may be arranged in a single row, so that the virtual radiators VR may also be formed in a single row.

For example, the virtual radiators VR may be spaced apart in the second direction from the reception radiators 152 arranged in a single row along the first direction, and may be formed in a single row along the first direction.

For example, at least one of the virtual radiators VR may face the reception radiator 152 while being spaced apart from the reception radiator 152 in the second direction.

For example, the reception radiator 152 and the virtual radiator VR may be arranged along a virtual axis (a second axis) parallel to the second direction and commonly passing through central points of the reception radiator 152 and the virtual radiator VR.

For example, the reception radiator 152 and the virtual radiator VR may be driven independently from each other. Accordingly, signal intensities according to the position or distance of the sensing object in the first direction and the second direction may each be measured. Thus, a signal change in each direction over time may be measured so that an action and a moving distance of the sensing object may be sensed.

For example, the antenna structure 100 may detect signals in two orthogonal axes (the first axis and the second axis). For example, the antenna structure 100 may transmit signal intensity changes in two orthogonal directions to a motion sensor driving circuit or a radar processor. The driving circuit or the processor may measure positional changes or distances in all directions on an X-Y coordinate system based on the collected information.

For example, the antenna structure may serve as a motion sensor capable of detecting a motion or a gesture on two axes perpendicular to each other, or may be used for a radar that detects a distance. The reception antenna unit 150 and the virtual radiators VR may serve as a reception radiation unit for the detection of the motion or the distance. For example, the reception radiators 152 and the virtual radiators VR may receive a signal reflected from the sensing object.

For example, the reception radiator 152 of the reception antenna unit arranged in a region where the first axis and the second axis intersect among the plurality of the reception antenna units 150 may serve as a reference point for measuring the signal intensity change. For example, a change in the position of the sensing object may be detected by measuring the signal intensity change in the first axis and the second axis based on the signal intensity of the reception radiator 152 arranged at the intersection region.

In some embodiments, each of the transmission radiators 112 and 122 and the reception radiators 152 may be designed to have, e.g., a resonance frequency in a high frequency or ultra-high frequency band of 3G, 4G, 5G, or more. In an embodiment, the resonance frequency of each of the transmission radiators 112 and 122 and the reception radiators 152 may be about 50 GHz or more, e.g., in a range from 50 GHz to 80 GHz, or from 55 GHz to 77 GHz.

In some embodiments, each of the plurality of the reception antenna unit 150 may include a reception transmitting line 154 connected to the reception radiator 152 and a reception sub-ground 156 disposed around the reception transmitting line 154.

For example, an antenna unit of substantially the same structure and material as the first transmission antenna unit 110 may be provided as the reception antenna unit 150.

For example, descriptions of the first transmission transmitting line 114, the first transmission sub-ground 116, the first transmission signal pad 118 and the first transmission ground pad 119 may be equally applied to the reception transmitting line 154, the reception sub-ground 156, a reception signal pad 158 and a reception ground pad 159, respectively.

In some embodiments, a spacing distance D1 between neighboring reception radiators among the plurality of the reception radiators 152 may be greater than or equal to 80% of the half-wavelength (λ/2) of the maximum resonance frequency.

For example, the spacing distance D1 between neighboring reception radiators among the plurality of the reception radiators 152 may be 90% or more, 95% or more, or 100% or more of the half-wavelength (λ/2) of the maximum resonance frequency.

For example, the spacing distance D1 between neighboring reception radiators among the plurality of the reception radiators 152 may be 150% or less, 120% or less, or 110% or less of the half-wavelength (λ/2) of the maximum resonance frequency.

For example, the spacing distance D1 between neighboring reception radiators among the plurality of the reception radiators 152 may be in a range from 80% to 150% of the half-wavelength (λ/2) of the maximum resonance frequency.

In one embodiment, the spacing distance D1 between neighboring reception radiators among the plurality of the reception radiators 152 may be the half-wavelength (2/2) of the maximum resonance frequency.

In some embodiments, a spacing distance D2 between the virtual radiator VR and the reception radiator 152 adjacent to the virtual radiator VR may be 80% or more of the half-wavelength (λ/2) of the maximum resonance frequency.

For example, the spacing distance D2 between the virtual radiator VR and the reception radiator 152 adjacent to the virtual radiator VR may be 90% or more, 95% or more, or 100% or more of the half-wavelength (λ/2) of the maximum resonance frequency.

For example, the spacing distance D2 between the virtual radiator VR and the reception radiator 152 adjacent to the virtual radiator VR may be 150% or less, 120% or less, or 110% or less of the half-wavelength (λ/2) of the maximum resonance frequency.

For example, the spacing distance D2 between the virtual radiator VR and the reception radiator 152 adjacent to the virtual radiator VR may be in a range from 80% to 150% of the half-wavelength (λ/2) of the maximum resonance frequency.

In one embodiment, the spacing distance D2 between the virtual radiator VR and the reception radiator 152 adjacent to the virtual radiator VR may be the half-wavelength (2/2) of the maximum resonance frequency.

Within the ranges of the spacing distances D1 and D2, desired radiation properties may be achieved while preventing mutual interference between the reception antenna unit 150 and the virtual radiator VR. Accordingly, signal loss and distortion may be prevented, thereby implementing high sensitivity and accuracy in, e.g., the motion or distance sensing.

For example, a distance between the reception antenna unit group and the transmission antenna unit group may be greater than or equal to the half-wavelength (λ) of the maximum resonance frequency.

For example, a spacing distance between the first transmission radiator 112 and the reception radiator 152 in the first direction may be greater than or equal to the half-wavelength (λ/2) of the maximum resonance frequency.

In an embodiment, the spacing distance between the first transmission radiator 112 and the reception radiator 152 in the first direction may be 80% or more of the half-wavelength (λ/2) of the maximum resonance frequency.

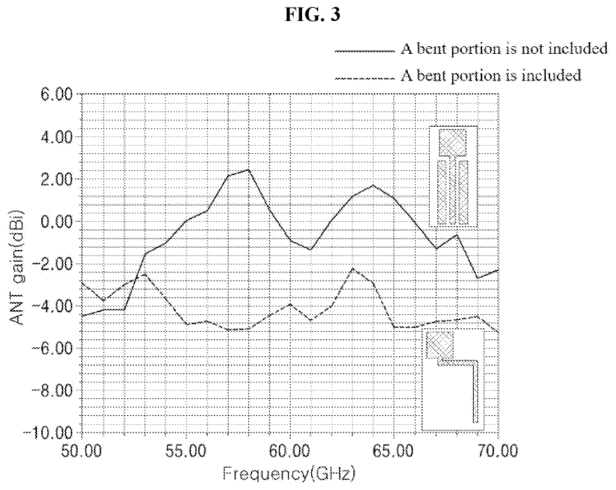

FIG. 3 is a graph showing antenna gains according to frequencies in Example and Comparative Example.

The antenna structure of Example shown in FIG. 3 includes the above-described reception radiator 150 formed on the dielectric layer 105 (not including a bent portion in the transmitting line). The antenna structure of Comparative Example shown in FIG. 3 includes a reception radiator having the same shape and size as those of the reception in Example formed on the same dielectric layer 105 as that of Example, but a bent portion at which an extension direction changes is formed in a transmitting line.

The bent portion may refer to a portion at which the extension direction of the transmitting line is changed from the first direction to the second direction or from the second direction to the first direction.

A power was supplied to the antenna structures according to Example and Comparative Example, and antenna gains from the reception radiators were measured by an HFSS simulator (manufactured by Ansys), and the results are shown in a graph of FIG. 3.

Referring to FIG. 3, the antenna gain of Example without the bent portion in the transmitting line was higher than that an antenna gain from Comparative Example including the bent portion.

In some embodiments, the reception transmitting lines 154 may extend in a single direction (e.g., the second direction). Accordingly, the reception transmitting lines 154 may not include the bent portion, and the antenna gain of the antenna structure 100 may be improved.

For example, the reception radiators 152 may be arranged in a line along the first axis. Accordingly, the reception transmitting lines 154 may extend in a single direction without a curved portion.

For example, the virtual radiators VR spaced apart from the reception radiators 152 in the second direction may be formed through the second transmission antenna unit 120. Accordingly, the positional change of the sensing object may be detected by measuring the signal intensity change in the first axis and the second axis without using a reception transmitting line including the bent portion.

In some embodiments, the transmission antenna unit group and the reception antenna unit group may be disposed at the same layer or at the same level on the dielectric layer 105.

For example, the first transmission transmitting line 114, the second transmission transmitting line 124 and the reception transmitting line 154 may be placed at the same layer or at the same level on the dielectric layer 105 as those of the first transmission radiator 112, the second transmission radiator 122 and the reception radiator 152, respectively.

The transmitting lines 114, 124, and 154 may be arranged at the same level as that of the radiators 112, 122 and 152, so that feeding/driving may be performed without a separate coaxial power supply for a signal input/output and a power supply. Thus, for example, an antenna on display (AoD) in which the antenna structure 100 is disposed on a display panel may be implemented.

In some embodiments, the first transmission transmitting line 114, the second transmission transmitting line 124 and the reception transmitting line 154 may be disposed at a different layer or a different level from that of the first transmission radiator 112, the second transmission radiator 122 and the reception radiator 152 on the dielectric layer 105. In this case, the transmitting lines 114, 124 and 154 and the radiators 112, 122 and 152 may be electrically connected to each other through a via.

In example embodiments, the transmission antenna unit group and the reception antenna unit group may include silver (Ag), gold (Au), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), tin (Sn), molybdenum (Mo), calcium (Ca) or an alloy containing at least one of the metals. These may be used alone or in a combination of at least two therefrom.

In an embodiment, the transmission antenna unit group and the reception antenna unit group may include silver (Ag) or a silver alloy (e.g., silver-palladium-copper (APC)), or copper (Cu) or a copper alloy (e.g., a copper-calcium (CuCa)) to implement a low resistance and a fine line width pattern.

In some embodiments, the transmission antenna unit group and the reception antenna unit group may include a transparent conductive oxide such as indium tin oxide (ITO), indium zinc oxide (IZO), indium zinc tin oxide (ITZO), zinc oxide (ZnOx), etc.

In some embodiments, the transmission antenna unit group and the reception antenna unit group may include a stacked structure of a transparent conductive oxide layer and a metal layer, and may include, e.g., a double-layered structure of a transparent conductive oxide layer-metal layer, or a triple-layered structure of a transparent conductive oxide layer-metal layer-transparent conductive oxide layer. In this case, flexible property may be improved by the metal layer, and a signal transmission speed may also be improved by a low resistance of the metal layer. Corrosive resistance and transparency may be improved by the transparent conductive oxide layer.

The transmission antenna unit group and the reception antenna unit group may include a blackened portion, so that a reflectance at a surface of the antenna structure 100 may be decreased to suppress a visual pattern recognition due to a light reflectance.

In an embodiment, a surface of the metal layer included in the transmission antenna unit group and the reception antenna unit group may be converted into a metal oxide or a metal sulfide to form a blackened layer. In an embodiment, a blackened layer such as a black material coating layer or a plating layer may be formed on the metal layer. The black material or plating layer may include silicon, carbon, copper, molybdenum, tin, chromium, molybdenum, nickel, cobalt, or an oxide, sulfide or alloy containing at least one therefrom.

A composition and a thickness of the blackened layer may be adjusted in consideration of a reflectance reduction effect and an antenna radiation property.

The radiators 112, 122 and 152 may include a polygonal shape such as a triangle, a square, a rhombus, a pentagon and a hexagon, and may include a circular shape.

FIGS. 4 and 5 are schematic plan views illustrating antenna structures in accordance with exemplary embodiments.

Referring to FIGS. 4 and 5, a plurality of the reception antenna units 150 may include three, or four or more reception antenna units 150. Accordingly, motion recognition performance or radar detection performance may be further improved.

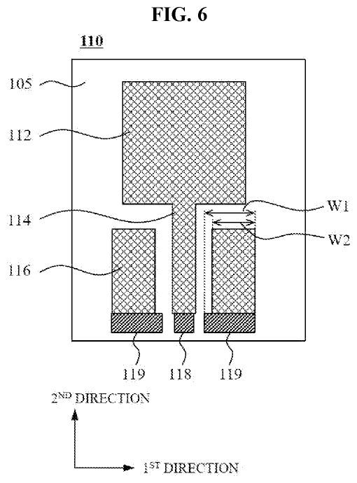

FIG. 6 is a schematic plan view illustrating an antenna unit in accordance with exemplary embodiments.

In FIG. 6, the first transmission antenna unit 110 is illustrated as an example. However, descriptions provided with reference to FIG. 6 may be equally applied to the second transmission antenna unit 120 and the reception antenna unit 150. For example, a relation between a length W1 of the first transmission ground pad in the first direction and a length W2 of the first transmission sub-ground 116 in the first direction may correspond to a relation between a length of the ground pad in the first direction and a length of the sub-ground in the first direction of each antenna unit.

Referring to FIG. 6, the length W1 of the first transmission ground pad in the first direction may be greater than the length W2 of the first transmission sub-ground 116 in the first direction. Accordingly, a distance between the first transmission sub-ground 116 and the first transmission transmitting line 114 may be sufficiently achieved, thereby preventing signal interference and disturbance.

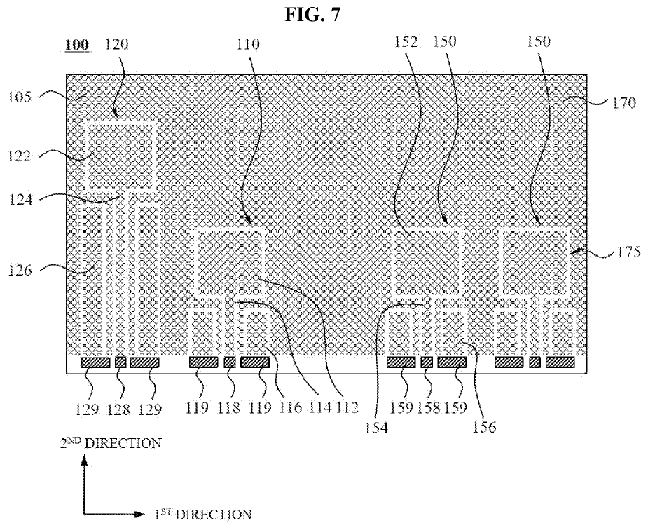

FIG. 7 is a schematic plan view illustrating an antenna structure in accordance with exemplary embodiments.

Referring to FIG. 7, each of the first transmission radiator 112, the second transmission radiator 122 and the reception radiator 152 may have a mesh structure.

Thus, an optical transmittance of the antenna structure 100 may be improved.

In example embodiments, the radiators 112, 122 and 152, the transmitting lines 114, 124 and 154 and the sub-grounds 116, 126 and 156 may entirely include the mesh structure.

In an embodiment, at least a portion of the transmitting lines 114, 124 and 154 may include a solid structure for improving driving properties, impedance matching and feeding efficiency of the antenna structure 100. For example, end portions of the transmitting lines 114, 124 and 154 may have a solid structure. In this case, the end portions of the transmitting lines 114, 124 and 154 may be provided as bonding portions with a circuit board.

In some embodiments, when portions of the transmitting lines 114, 124 and 154 have the solid structure, portions of the sub-grounds 116, 126 and 156 may also have the solid structure.

In some embodiments, the signal pads 118, 128 and 158 and the ground pads 119, 129 and 159 may have the solid structure. For example, the signal pads 118, 128 and 158 and the ground pads 119, 129 and 159 may be provided as bonding portions with the circuit board.

In some embodiments, the antenna structure 100 may further include a dummy mesh pattern 170 disposed around the antenna units 110, 120 and 150. For example, the dummy mesh pattern 170 may be electrically and physically separated from the radiators 112, 122 and 152, the transmitting lines 114, 124 and 154 and the sub-grounds 116, 126 and 156 by a separation region 175.

For example, a conductive layer including the above-described metal or alloy may be formed on the dielectric layer 105. A mesh structure may also be formed when etching the conductive layer along a profile of the antenna units 110, 120 and 150. Accordingly, the dummy mesh pattern 170 spaced apart from the antenna units 110, 120 and 150 may be formed by the separation region 175.

The dummy mesh pattern 170 may be distributed, so that the transmittance of the antenna structure 100 may be improved, and optical properties around the radiators 112, 122, and 152 may become uniform. Thus, the antenna structure 100 and a pattern shape may be prevented from being visually recognized.

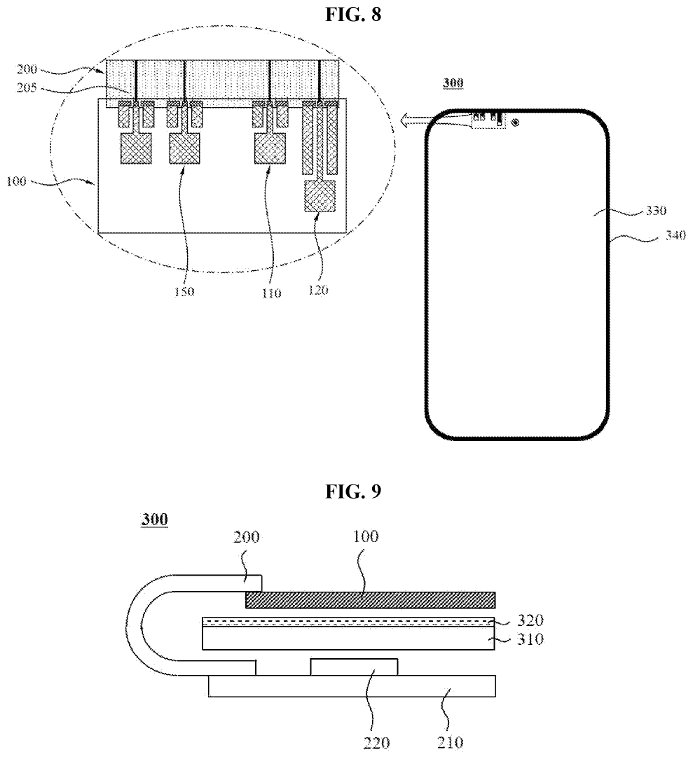

FIGS. 8 and 9 are a schematic plan view and a cross-sectional view illustrating an image display device in accordance with exemplary embodiments.

FIG. 8 shows a front portion or a window face of an image display device 300. The front portion of the image display device 300 may include a display area 330 and a non-display area 340. The non-display area 340 may correspond to, e.g., a light-shielding portion or a bezel portion of the image display device 300.

The antenna structure 100 according to exemplary embodiments may be disposed toward the front portion of the image display device 300, and may be disposed on, e.g., a display panel.

In some embodiments, the above-described antenna structure 100 may be attached to the display panel in the form of a film.

In an embodiment, the antenna structure 100 may be formed commonly over the display area 330 and the non-display area 340 of the image display device 300. In an embodiment, the radiators 112, 122 and 152 may be at least partially disposed on the display area 330.

As described above, portions of the transmitting lines 114, 124 and 154 have the solid structure, so that the signal pads 118, 128 and 158 and the ground pads 119, 129 and 159 may overlap the non-display area 340. For example, portions of the antenna units 110, 120 and 150 having the solid structure may overlap the non-display area 340.

In some embodiments, the antenna structure 100 may be located at a central portion of one side of the image display device 300. Accordingly, the motion detection performance on any side may be prevented from being deteriorated, and a motion or an action of the sensing object may be detected in all directions on the front portion of the image display device 300.

Feeding or driving of the antenna structure 100 may be implemented through a circuit board 200.

In some embodiments, one end portions of the transmitting lines 114, 124 and 154 may be connected to the radiators 112, 122 and 152, and the other end portions of the transmitting lines 114, 124 and 154 may be bonded to the circuit board 200.

The circuit board 200 may include, e.g., a flexible printed circuit board (FPCB). For example, a conductive bonding structure such as an anisotropic conductive film (ACF) may be bonded onto the other end portions of the transmitting lines 114, 124 and 154, and then the circuit board 200 may be heat-pressed on the conductive bonding structure.

The circuit board 200 may include a circuit wiring 205 bonded to the other end portions of the transmitting lines 114, 124 and 154. The circuit wiring 205 may serve as an antenna feeding wiring. For example, one end portion of the circuit wiring 205 may be exposed to an outside, and the exposed one end portion of the circuit wiring 205 may be bonded onto the transmitting lines 114, 124 and 154. Thus, the circuit wiring 205 and the antenna structure 100 may be electrically connected.

An antenna driving IC chip may be mounted on the circuit board 200. In an embodiment, an intermediate circuit board such as a rigid printed circuit board may be disposed between the circuit board 200 and the antenna driving IC chip. In an embodiment, the antenna driving IC chip may be directly mounted on the circuit board 200.

A motion sensor driving circuit may be mounted on the circuit board 200. For example, the antenna structure 100 and the circuit board 200 may be electrically connected, so that signal transmission/reception information of the antenna structure 100 may be transmitted to the motion sensor driving circuit. Therefore, a motion recognition sensor including the antenna structure 100 may be provided.

Referring to FIG. 9, the image display device 300 may include a display panel 310 and the above-described antenna structure 100 disposed on the display panel 310.

In example embodiments, an optical layer 320 may be further included on the display panel 310. For example, the optical layer 320 may be a polarizing layer including a polarizer or a polarizing plate.

In an embodiment, a cover window may be disposed on the antenna structure 100. The cover window may include, e.g., glass (e.g., ultra-thin glass (UTG)) or a transparent resin film. Accordingly, an external impact applied to the antenna structure 100 may be reduced or alleviated.

For example, the antenna structure 100 may be disposed between the optical layer 320 and the cover window. In this case, the optical layer 320 may serve as an antenna dielectric layer of the radiators 112, 122 and 152 together with the dielectric layer 105. Accordingly, an appropriate dielectric constant may be achieved, and thus the motion sensing performance of the antenna structure 100 may be sufficiently achieved.

For example, the optical layer 320 and the antenna structure 100 may be stacked by a first adhesive layer, and the antenna structure 100 and the cover window may be stacked by a second adhesive layer.

The circuit board 200 (e.g., the flexible printed circuit board) may be bent along a lateral bending profile of the display panel 310 and disposed at a rear portion of the image display device 300 to extend toward an intermediate circuit board 210 (e.g., a main board) on which the driving IC chip is mounted.

The circuit board 200 and the intermediate circuit board 210 may be bonded or interconnected through a connector, so that the feeding to the antenna structure 100 and antenna driving control may be performed by an antenna driving IC chip.

In some embodiments, a motion sensor driving circuit 220 may be mounted on the intermediate circuit board 210. In an embodiment, the motion sensor driving circuit 220 may include a proximity sensor, a gesture sensor, an acceleration sensor, a gyroscope sensor, a position sensor, a magnetic sensor, etc.

In some embodiments, the radiators 112, 122 and 152 may be coupled to the motion sensor driving circuit 220.

In an embodiment, the antenna structure 100 may be electrically connected to the motion sensor driving circuit 220 through the flexible circuit board 200 that may be bonded or interconnected to the intermediate circuit board 210. Thus, the signal intensity changes in the first direction and the second direction of the antenna structure 100 may be transmitted/provided to the motion sensor driving circuit 220.

In an embodiment, signal intensities of the reception radiators and the virtual radiators VR according to the movement of the sensing object from a specific first position to a specific second position may be measured, so that the action of the sensing object may be measured. For example, the motion sensor driving circuit 220 coupled to the antenna structure 100 may detect the action by measuring the signal intensity change between the reception radiators 152, the signal intensity change between the reception radiator 152 and the virtual radiator VR, and the signal intensity change between the virtual radiators VR corresponding to a movement from the first position to the second position.

For example, the movement of the sensing object in the first direction may be detected by a plurality of the reception radiators 152 and/or the virtual radiators VR. For example, a movement of the sensing object in the second direction may be detected by the reception radiator 152 and the virtual radiator VR. Therefore, the signal intensity changes according to the action operation/position on two axes perpendicular to each other may be provided from the antenna structure 100 to the motion sensor driving circuit 220. The motion sensor driving circuit 220 may measure the action, the motion and the distance according to each axis.

For example, the formation of the virtual radiators VR may provide more accurate measurement of the signal intensity change, thereby improving the precision of a motion tracking in azimuth and elevation angle directions.

In an embodiment, the motion sensor driving circuit 220 may include a motion detection circuit. A signal information transmitted from the antenna structure 100 may be converted/calculated into a location information or a distance information through the motion detection circuit.

In an embodiment, the antenna structure 100 may be electrically connected to a radar sensor circuit. Accordingly, the signal transmission/reception information may be transmitted to the radar processor. For example, the antenna structure 100 may be electrically connected to a radar processor through the circuit board 200 and the intermediate circuit board 210. Thus, a radar sensor including the antenna structure 100 may be provided.

The radar sensor may detect information on the sensing object by analyzing a transmission signal and a reception signal. For example, the antenna structure 100 may measure a distance to the sensing object by transmitting the transmission signal and receiving the reception signal reflected by the sensing object.

For example, the distance to the sensing object may be calculated by measuring a time required for the signal transmitted from the antenna structure 100 to be reflected on the sensing object and received back to the antenna structure 100.

What is claimed is:

1. An antenna structure comprising:
a transmission antenna unit group; and
a reception antenna unit group spaced apart from the transmission antenna unit group in a first direction,
wherein the transmission antenna unit group comprises:
a first transmission antenna unit; and
a second transmission antenna unit having a length in a second direction greater than a length of the first transmission antenna unit in the second direction, the second direction being perpendicular to the first direction,
wherein the reception antenna unit group comprises a plurality of reception antenna units spaced apart from the first transmission antenna unit in the first direction and being arranged in a single row along the first direction.

2. The antenna structure according to claim 1, wherein the second transmission antenna unit is spaced apart from the reception antenna unit group in the first direction with the first transmission antenna unit interposed therebetween.

3. The antenna structure according to claim 1, wherein the first transmission antenna unit comprises a first transmission radiator, a first transmission transmitting line connected to the first transmission radiator, and a first transmission sub-ground disposed around the first transmission transmitting line, and
the second transmission antenna unit comprises a second transmission radiator, a second transmission transmitting line connected to the second transmission radiator, and a second transmission sub-ground disposed around the second transmission transmitting line.

4. The antenna structure according to claim 3, wherein a spacing distance between the first transmission radiator and the second transmission radiator in the first direction is in a range from 80% to 150% of a half-wavelength (λ/2) of a maximum resonance frequency, and
a spacing distance between the first transmission radiator and the second transmission radiator in the second direction is in a range from 80% to 150% of the half-wavelength (λ/2) of the maximum resonance frequency.

5. The antenna structure according to claim 3, wherein a length of the second transmission transmitting line in the second direction is greater than a length of the first transmission transmitting line in the second direction.

6. The antenna structure according to claim 3, wherein a length of the second transmission sub-ground in the second direction is greater than a length of the first transmission sub-ground in the second direction.

7. The antenna structure according to claim 3, wherein the first transmission antenna unit further comprises a first transmission signal pad connected to one end portion of the first transmission transmitting line, and a first transmission ground pad disposed around the first transmission signal pad, and
the second transmission antenna unit further comprises a second transmission signal pad connected to one end portion of the second transmission transmitting line, and a second transmission ground pad disposed around the second transmission signal pad.

8. The antenna structure according to claim 7, wherein a length of the first transmission sub-ground in the first direction is smaller than a length of the first transmission ground pad in the first direction.

9. The antenna structure according to claim 1, wherein each of the plurality of reception antenna units comprises a reception radiator, and a plurality of the reception radiators are ranged in a single row along the first direction.

10. The antenna structure according to claim 9, wherein a spacing distance between neighboring reception radiators among the reception radiators included in the plurality of reception antenna units is in a range from 80% to 150% of a half-wavelength (λ/2) of a maximum resonance frequency.

11. The antenna structure according to claim 9, wherein each of the plurality of reception antenna units comprises a reception transmitting line connected to the reception radiator and a reception sub-ground disposed around the reception transmitting line.

12. The antenna structure according to claim 11, wherein the reception antenna unit further comprises a reception signal pad connected to one end portion of the reception transmitting line, and a reception ground pad disposed around the reception signal pad.

13. The antenna structure according to claim 1, further comprising a dielectric layer on which the transmission antenna unit group and the reception antenna unit group are disposed,
wherein the transmission antenna unit group and the reception antenna unit group are disposed at the same level on the dielectric layer.

14. A motion recognition sensor comprising the antenna structure according to claim 1.

15. A radar sensor comprising the antenna structure according to claim 1.

16. An image display device, comprising:
a display panel; and
the antenna structure according to claim 1 disposed on the display panel.
